(19) United States
(12) Patent Application Publication
(10) Pub. No.: US 2009/0276804 A1
(43) Pub. Date: Nov. 5, 2009

(54) Information output apparatus, electronics conference system, information output method, and storage medium in which control program is stored

(75) Inventors: Kazuyuki Hamada, Osaka (JP); Hitoshi Nagahama, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka-shi (JP)

(21) Appl. No.: 12/453,048

(22) Filed: Apr. 28, 2009

(30) Foreign Application Priority Data
Apr. 30, 2008 (JP) 2008-118933

(51) Int. Cl. H04N 7/025; G08B 7/00; H04N 5/225

(52) U.S. Cl. 725/33; 340/691.6; 348/207.2; 348/E05.024

(57) ABSTRACT

When a signal detection section detects a signal of an earthquake early warning, a control section (i) causes a storage apparatus to store display information being displayed on a display apparatus, (ii) reads, out of the storage apparatus, information on instructions in the event of an earthquake and an evacuation map in the event of an earthquake, (iii) causes the display apparatus to display: information on the instructions and the evacuation map; and information on the earthquake early warning and (iv) causes a printing apparatus to print the information on the instructions and the evacuation map. This allows a user to be appropriately evacuated from an installation site of the display apparatus.

This Nonprovisional application claims priority under 35 U.S.C. §119(a) on Patent Application No. 2008-118933 filed in Japan on Apr. 30, 2008, the entire contents of which are hereby incorporated by reference.

1. Technical Field

This invention relates to an apparatus for evacuating a user in an appropriate manner in a case where a signal of emergency information is detected.

2. Background Art

Currently, an earthquake forecast, a tsunami forecast or the like has been broadcasted on TV as a prompt report. However, for example, assume that a conference is taken place by using a display apparatus for displaying information. In this case, when an earthquake or a tsunami occurs, it is impossible for conference participants to obtain disaster information such as an earthquake forecast and a tsunami forecast. Therefore, the conference participants cannot obtain any information as to (i) instructions on how to act in a conference room in the event of an earthquake or a tsunami, and (ii) an evacuation route. This increases a risk that the conference participants are affected by the disaster.

In view of this, there is a technique for detecting and separating a transmitted emergency information signal and combining the emergency information signal with desired video/audio signals, even in a case where a user does not view and/or listen to TV or the like or a user watches a video stored in a recording apparatus (for example, refer to Patent Literature indicated below). In this case, even if the user is not viewing a program in which the emergency information signal is broadcasted, the user can obtain emergency information in real time.

### CITATION LIST

[Patent Literature 1]

Japanese Patent Application Publication, Tokukai, No. 2002-262192 A (Publication Date: Sep. 13, 2002)

However, although the above-mentioned conventional technique allows a user to obtain emergency information, this technique does not allow the user to obtain information on: instructions in the event of a disaster; an evacuation route; and the like. Because of this, there is a risk that the user is un necessarily caught in a disaster. For example, in a case where a user attends a conference taken place in a conference room in a building, it is not certain that, when a disaster occurs, the user can obtain instructions or an evacuation route suitable for a location of the conference room or the environment. Therefore, it cannot be said that the user can successfully secure his/her own safety.

### SUMMARY OF INVENTION

The present invention is made in view of the foregoing situation, and an object of the present invention is to provide an information output apparatus for evacuating a user who is in an installation site of a display apparatus in an appropriate manner.

An information output apparatus includes: a signal receiving apparatus; a display apparatus; a printing apparatus; a signal detection section for detecting, from a signal received by the signal receiving apparatus, a signal of emergency information that is information for an emergency situation; a storage apparatus for storing evacuation information that is associated with the emergency information and is used in an evacuation from an installation site of the display apparatus; and a control section which, if the signal detection section detects the signal of the emergency information, (i) causes the storage apparatus to store display information that is being displayed on the display apparatus, (ii) reads the evacuation information out of the storage apparatus, (iii) causes the display apparatus to display the evacuation information and the emergency information, and (iv) causes the printing apparatus to print out the evacuation information, the storage apparatus employing an optical information storage medium including: a first storage layer which allows only information reading by use of a laser beam, in which first storage layer the evacuation information is stored; and a second storage layer which is a re-writable storage layer, the control section causing the second storage layer to store the display information, and reading the evacuation information out of the first storage layer.

With the arrangement, if the signal of the emergency information is detected, (i) the display information that is being displayed on the display apparatus at the time is stored in the storage apparatus, (ii) the emergency information, and the evacuation information that is associated with the emergency information and is used in the evacuation from the installation site of the display apparatus are displayed on the display apparatus, and (iii) the evacuation information is printed out by the printing apparatus. Thus, when the signal of the emergency information is detected, a user who is in the installation site of the display apparatus can (i) detect the emergency information displayed on the display apparatus, (ii) check the evacuation information, and (iii) be evacuated. Further, the evacuation information is printed out so that the user can be evacuated while carrying the printed matter. Here, the evacuation information is the information used in the evacuation from the installation site of the display apparatus. That is, the evacuation information is customized in accordance with the installation site of the display apparatus. The user is evacuated while carrying the printed matter on which the evacuation information customized in accordance with the installation site of the display apparatus is printed. Thereby, the user can be evacuated without losing his/her way or getting into a panic in an emergency situation. Thus, with the arrangement, it is possible to appropriately evacuate a user from an installation site of the display apparatus. The evacuation information may be any information as long as it is information for use in the evacuation from the installation site of the display apparatus. For example, the evacuation information may be information indicating an evacuation route, or instructions that are necessary for the evacuation.

Further, with the arrangement, the evacuation information is stored on the first storage layer that is a read-only storage layer. Therefore, it is possible to prevent the evacuation information from being leaked or altered.

Furthermore, with the arrangement, if the signal detection section detects the signal of the emergency information, the display information that is being displayed on the display apparatus is written on the second storage layer. Therefore, it becomes possible to store the display information that is being displayed on the display apparatus at the time of the detection, and also read out the display information anytime it is needed after a user escapes from the emergency situation.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1

FIG. 1 is a block diagram illustrating an information output system according to First Embodiment of the present invention.

FIG. 2

FIG. 2 is a view illustrating a first display example of a display section according to First Embodiment of the present invention.

FIG. 3

FIG. 3 is a view illustrating a second display example of the display section according to First Embodiment of the present invention.

FIG. 4

FIG. 4 is a perspective view of an information output system according to First Embodiment of the present invention.

FIG. 5(a)

FIG. 5(a) is a schematic view of an optical information storage medium according to First Embodiment of the present invention.

FIG. 5(b)

FIG. 5(b) is a cross-sectional view of the optical information storage medium illustrated in FIG. 5(a).

FIG. 6

FIG. 6 is a view indicating attributes of information that will be stored in the optical information storage medium illustrated in FIG. 5.

FIG. 7

FIG. 7 is a flow chart illustrating a process carried out by the information output system according to First Embodiment of the present invention.

FIG. 8

FIG. 8 is a block diagram illustrating an information output system according to Second Embodiment of the present invention.

FIG. 9

FIG. 9 is a view illustrating a display example of a display section according to Second Embodiment of the present invention.

FIG. 10

FIG. 10 is a flow chart illustrating a process carried out by the information output system according to Second Embodiment of the present invention.

FIG. 11

FIG. 11 is a block diagram illustrating an information output system according to Third Embodiment of the present invention.

### DESCRIPTION OF EMBODIMENTS

The following describes embodiments of the present invention with reference to the attached drawings.

### First Embodiment

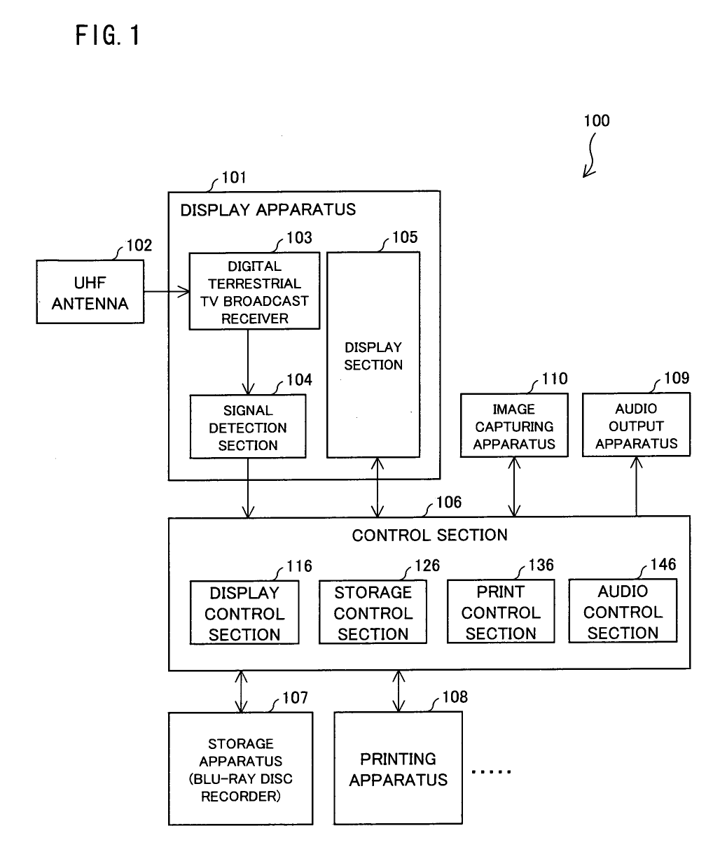

FIG. 1 is a block diagram illustrating an information output system (information output apparatus, electronic conference system) 100 according to First Embodiment of the present invention. The information output system 100 includes a display apparatus 101, a control section 106, a storage apparatus 107, a printing apparatus 108, and an audio output apparatus 109. The following embodiment describes a case where the information output system 100 is used in a conference. The information output system 100 is arranged to, in a case where emergency information is detected, (i) store, in the storage apparatus 107, conference proceedings data which is being outputted on the display apparatus 101 at the time, (ii) read, out of the storage apparatus 107, instructions in an emergency situation indicated by the emergency information, an evacuation route map, and the like, and (iii) display and print out the instructions, the evacuation route map, and the like. The “emergency information” refers to information given in a case of emergency, and is hereinafter explained as an “earthquake early warning”.

The display apparatus 101 includes: a digital terrestrial TV broadcast receiver (signal receiving apparatus) 103 connected to a UHF antenna 102; a signal detection section 104; and a display section 105. Note that the digital terrestrial TV broadcast receiver 103 and the signal detection section 104 may be separated from the display apparatus 101.

Further, the display apparatus 101 is provided with a touch panel (not illustrated). On the touch panel, it is possible to input coordinates by using a touch pen or the like so as to input figures, characters, symbols, and/or the like while changing a thickness and a color of a line thereof, as appropriate.

The signal detection section 104 and the display section 105 are connected to the control section 106, and the control section 106 is connected to the storage apparatus 107, the printing apparatus 108, and the audio output apparatus 109. Each of the connections may be either a wired connection or a wireless connection. Examples of the wired connection may encompass a LAN cable, Fast Ethernet (Registered Trademark), Gigabit Ethernet, USB2.0, and USB3.0. However, the wired connection is not limited to these. Examples of the wireless connection may encompass a wireless LAN, Bluetooth (Registered Trademark), ZigBee (Registered Trademark), a Wireless USB (UWB), mobile WiMAX (e.g., third generation mobile wireless (3G), fourth generation mobile wireless (4G)), infrared radiation, and optical wireless (including LED optical wireless). However, the wireless connection is not limited to these.

The digital terrestrial TV broadcast receiver 103 receives a signal from a digital terrestrial TV broadcast station via the UHF antenna 102. The signal thus received is transmitted to the control section 106 via the signal detection section 104.

The signal detection section 104 detects the signal received by the digital terrestrial TV broadcast receiver 103. The signal detection section 104 detects, from the signal received by the digital terrestrial TV broadcast receiver 103, a signal of an earthquake early warning. Then, the signal detection section 104 transmits, to the control section 106, the signal of the earthquake early warning and a signal indicating that the signal of the earthquake early warning has been detected.

The display section 105 may be suitably realized by a liquid crystal display, a plasma display panel, a field emission display, a surface-conduction electron-emitter display, a plasma tube array display, an organic electro-luminescence display, a rear projection display, an electronic paper display or the like. Further, the display section 105 is controlled by the control section 106 so as to carry out various display operations.

The storage apparatus 107 stores conference proceedings data, and also stores evacuation information containing (i) instructions in the event of an earthquake and (ii) an evacuation route map used in the event of an earthquake (described later). This evacuation information is customized in accordance with a place (here, a conference room) where the display apparatus 101 or the information output system 100 is installed, for example, in accordance with a position in a building having the conference room, the environment, or site conditions of the building. In the present embodiment, the storage apparatus 107 is an apparatus for (i) writing information on a Blu-ray disc (optical information storage medium) and (ii) reading information out of the Blu-ray disc.

The control section 106 includes a display control section 116 for controlling the display apparatus 101, a storage control section 126 for controlling the storage apparatus 107, a print control section 136 for controlling the printing apparatus 108, and an audio control section 146 for controlling the audio output apparatus 109, and carries out various kinds of control with respect to the information output system 100. Note that the control section 106 may be included in the display apparatus 101. Further, the information output system 100 may be provided with a controller for carrying out an input with respect to the control section 106.

Assume that a conference is taken place while (i) conference proceedings and the like are displayed on the display section 105 of the display apparatus 101 and (ii) an operator (not illustrated) writes figures, characters, symbols, and/or the like by using a touch pen so as to enter conference proceedings data.

Turning on a power source (not illustrated) of the display apparatus 101 enables the digital terrestrial TV broadcast receiver 103 and the signal detection section 104 to be ready for operation. It is preferable that, at the same time as when the power source (not illustrated) of the display apparatus 101 is turned on, power sources of the control section 106, the storage apparatus 107, and the printing apparatus 108 are also turned on and thereby the control section 106, the storage apparatus 107, and the printing apparatus 108 become ready for operation. However, the present invention is not limited to this. It is possible to have another arrangement in which the power sources are individually turned on so that the control section 106, the storage apparatus 107, and the printing apparatus 108 become ready for operation individually.

Operation from (i) storing conference proceedings data in the storage apparatus 107 to (ii) reading, out of the storage apparatus 107, instructions in various emergency situations and an evacuation route map is defined as a “read-out mode setting”. Here, turning on the power source (not illustrated) of the display apparatus 101 automatically switches the read-out mode setting to an ON state. The read-out mode setting is canceled (OFF) by selecting, with use of an input device such as a touch pen (not illustrated), an icon or the like (not illustrated) displayed on the display section 105. Further, it is also possible for an operator to switch the read-out mode setting to the ON state by selecting, with use of the input device such as the touch pen (not illustrated), an icon (not illustrated) displayed on the display section 105.

In this context, the operation from (i) storing the conference proceedings data in the storage apparatus 107 to (ii) reading, out of the storage apparatus 107, the information in the various emergency situations and the evacuation route map is defined as the read-out mode setting. However, it is possible to have an arrangement in which (i) storing the conference proceedings data in the storage apparatus 107 is defined as a first mode, (ii) reading, out of the storage apparatus 107, the information in the various emergency situations and the evacuation route map is defined as a second mode, and (iii) the first mode and the second mode are individually set (ON/OFF).

Here, assume that the digital terrestrial TV broadcast receiver 103 has received a signal containing an earthquake early warning from a digital terrestrial TV broadcast station (not illustrated) via a UHF antenna 102 with the read-out mode setting being in the ON state. In this case, the signal detection section 104 detects a signal of the earthquake early warning, and transmits, to the control section 106, a signal indicating that the signal of the earthquake early warning has been detected. Further, the signal of the earthquake early warning received by the digital terrestrial TV broadcast receiver 103 is transmitted to the control section 106 via the signal detection section 104. When the control section 106 receives, from the signal detection section 104, the signal indicating that the signal containing the earthquake early warning has been detected, the control section 106 carries out the following processing.

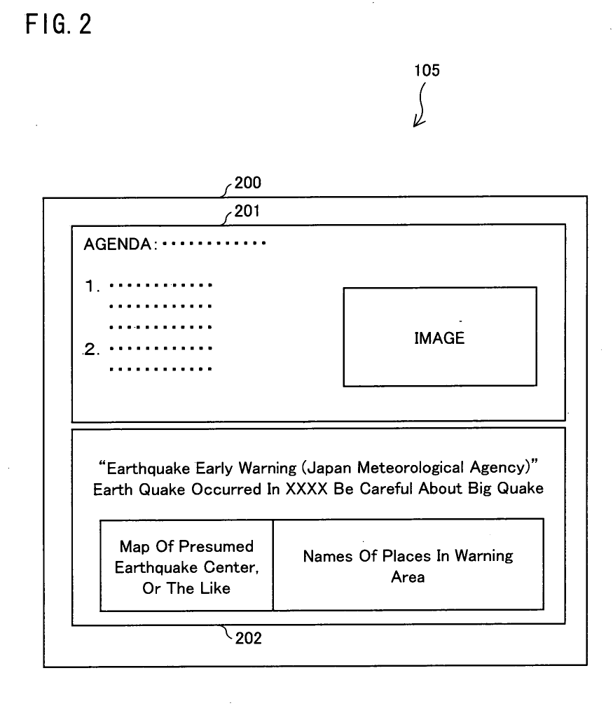

The display control section 116 transmits, to the display section 105, video data and character data of the earthquake early warning, and causes the display section 105 to display the video data and the character data. Further, the audio control section 146 transmits, to the audio output apparatus 109, audio information of the earthquake early warning, and controls audio output. One display example of the display section 105 in this case is illustrated in FIG. 2. An upper half of a display screen 200 of the display section 105 displays conference proceedings data 201, and a lower half of the display screen 200 displays video data and character data 202 of the earthquake early warning.

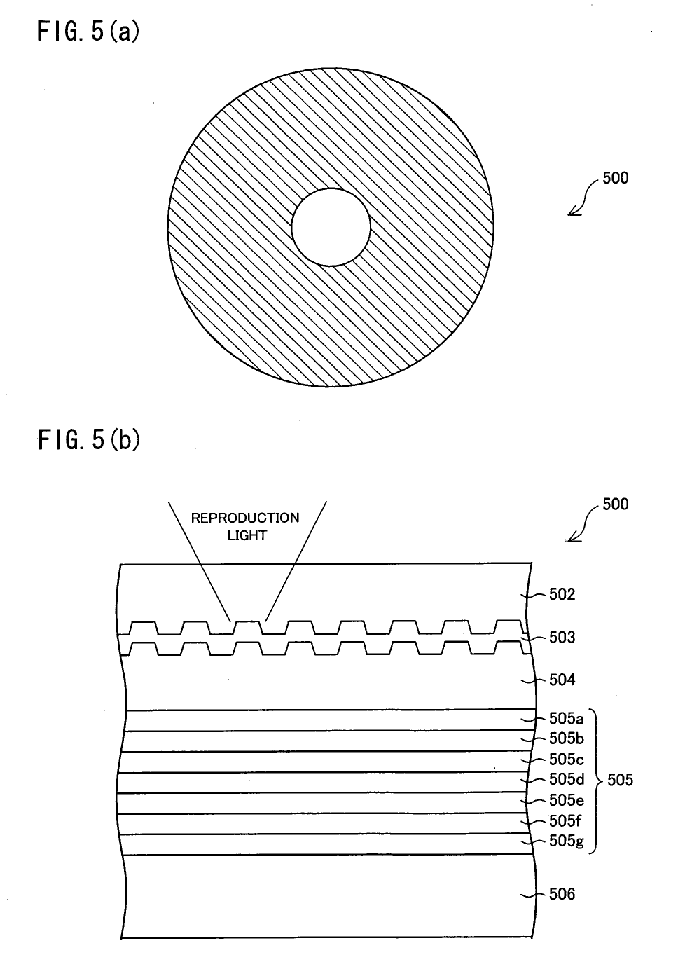

Furthermore, the storage control section 126 causes the storage apparatus 107 to store the conference proceedings data 201, and reads, out of the storage apparatus 107, evacuation information containing (i) instructions in the event of an earthquake and (ii) an evacuation route map used in the event of an earthquake. This evacuation information contains video data, audio data, and print data. Further, as described above, the evacuation information is customized in accordance with a place where the information output system 100 or the display apparatus 101 is installed. Here, the conference proceedings data 201 is stored in the storage apparatus 107 in such a manner that the conference proceedings data 201 is stored on a second information storage layer 505, which is an RE layer of a Blu-ray disc (optical information storage medium) illustrated in FIG. 5 (described later). Further, the evacuation information containing (i) the instructions in the event of an earthquake and (ii) the evacuation route map is read out of the storage apparatus 107 in such a manner that the evacuation information is read out of a first information storage layer (first storage layer) 503, which is a ROM layer of the Blu-ray disc (optical information storage medium).

The first information storage layer 503 may be a write-once R layer, on which writing is performable only once, or may have a multi-layer structure of a combination of a ROM layer and an R layer, a multi-layer structure of ROM layers, or a multi-layer structure of R layers.

Then, the display control section 116 transmits the video data of the evacuation information to the display apparatus 101, and causes the display section 105 to display the video data. In sync with this, the audio control section 146 causes the audio output apparatus 109 to output the audio data of the evacuation information as audio. Further, in synch with this, the print control section 136 transmits the print data of the evacuation information to the printing apparatus 108, and causes the printing apparatus 108 to print out the print data. Here, note that the control section 106 is connected with an image capturing apparatus 110. Based on image data obtained in such a manner that the image capturing apparatus 110 captures an image of conference participants, the print control section 136 may count how many the conference participants are included in the image data, and cause the printing apparatus 108 to carry out printing on sheet(s) as many as the count of the conference participants. This allows the print data to be printed out for each of the conference participants. This makes it possible to provide the printed matters to all of the conference participants.

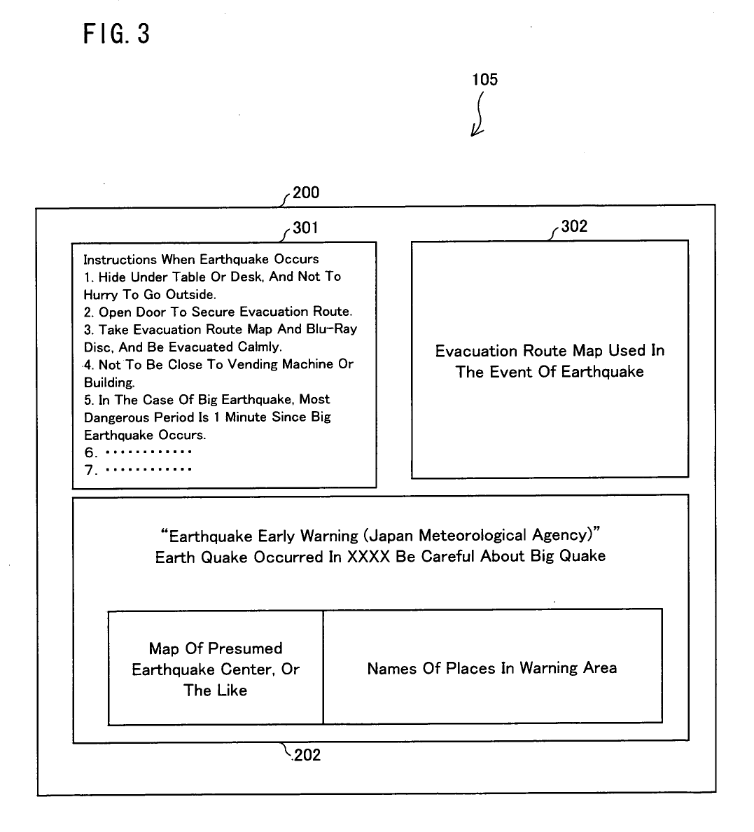

FIG. 3 shows a display example of the display section 105 in this case. On the display screen 200 of the display section 105, the following information is displayed: instructions 301 in the event of an earthquake (information on instructions in the event of a disaster) titled “INSTRUCTIONS WHEN EARTHQUAKE OCCURS”; an evacuation route map 302 (information on an evacuation route) used in the event of an earthquake; and video data and character data 202 of the earthquake early warning. The audio data outputted at this time is data corresponding to the instructions 301 in the event of an earthquake. Further, the print data is data for printing (i) the instructions 301 in the event of an earthquake and (ii) the evacuation route map 302 used in the event of an earthquake.

As described above, the present embodiment is arranged such that (i) the display section 105 firstly displays the conference proceedings data 201 and the video data and character data 202 of the earthquake early warning, as shown in FIG. 2, and then (ii) the display section 105 displays (i) the instructions 301 in the event of an earthquake, (ii) the evacuation route map 302 used in the event of an earthquake, and (iii) the video data and character data 202 of the earthquake early warning, as shown in FIG. 3. However, it is also possible that after the conference proceedings data 201 is stored in the storage apparatus 107, a screen as shown in FIG. 3 is displayed on the display section 105, without displaying a screen as shown in FIG. 2.

Thus, by using the information output system 100 including the control section 106, a conference participant (user) can obtain, in the forms of video and audio, (i) instructions in the event of an earthquake and (ii) an evacuation route map used in the event of an earthquake, while viewing and listening to an earthquake early warning in real time. Besides, by using the information output system 100 including the control section 106, a conference participant can be evacuated while carrying a sheet (printed matter) on which the instructions in the event of an earthquake, the evacuation route map, and the like are printed.

Here, (i) the instructions in the event of an earthquake and (ii) the evacuation route map used in the event of an earthquake are customized in accordance with an installation site of the display apparatus 101. Because of this, the conference participant can be evacuated while carrying a printed matter on which the evacuation information, customized in accordance with the installation site of the display apparatus 101, is printed. Therefore, in a case of emergency, it is possible for the conference participant to be evacuated without losing his/her way or getting into a panic. Thus, the information output system 100 enables a user in the place where the display apparatus 101 is installed to be evacuated appropriately. Further, the information output system 100 enables the user to be evacuated while the user carries a Blu-ray disc in which conference proceedings data is stored. Thus, it is possible for all the conference participants to be evacuated in safety.

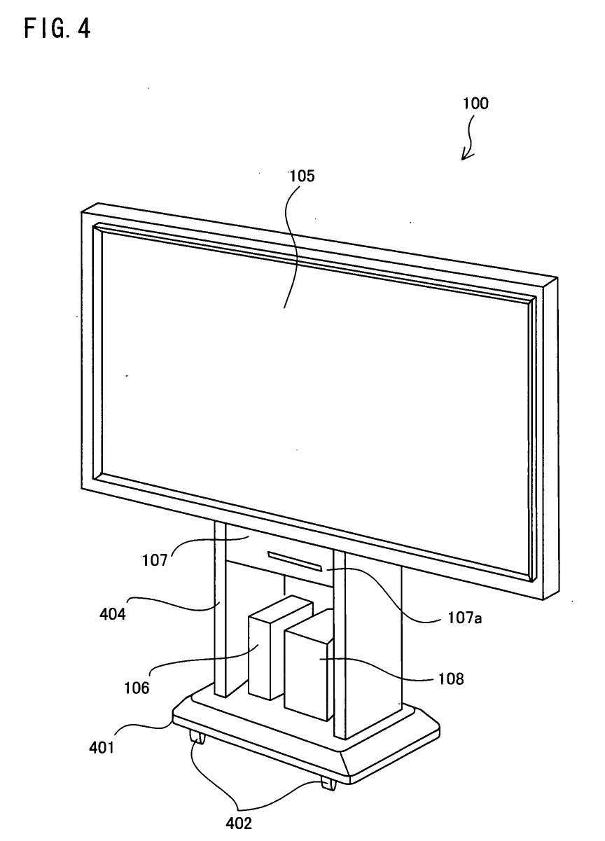

FIG. 4 illustrates a perspective view of the information output system 100 according to the present embodiment. The information output system 100 includes the display apparatus 101, the control section 106, the storage apparatus 107, the printing apparatus 108, and the audio output apparatus 109 each of which is as described above. The storage apparatus 107 includes a tray 107a from which a Blu-ray disc is inserted and ejected. Further, the information output system 100 is provided with a leg section 404 and a base 401 both of which support the display section 105 of the display apparatus 101. Furthermore, the information output system 100 is provided with wheels 402 for moving the information output system 100. Note that the display section 105 of the display apparatus 101 may be a wall-hanging type that is hung against a wall in a place where the information output system 100 is set or a type that is integrally embedded into the wall, and the arrangement of the display section 105 may be modified as appropriate. In FIG. 4, the image capturing apparatus 110 is not illustrated.

Next, the following describes one example of a Blu-ray disc used in the storage apparatus 107. FIG. 5(a) is a schematic view of a Blu-ray disc 500, and FIG. 5(b) is a cross-sectional view of the Blu-ray disc 500. As illustrated in FIG. 5(b), the Blu-ray disc 500 is arranged so as to include a light-transmitting layer 502, the first information storage layer 503, an intermediate layer 504, the second information storage layer (second storage layer) 505, and a substrate 506, in this order from a side from which reproduction light enters. Reproduction light to be irradiated onto the Blu-ray disc 500 is a blue-violet laser (wavelength: approximately 405 nm), which is within a blue visible light range.

The light-transmitting layer 502 is made of, for example, ultraviolet-cured resin having a thickness of 75 μm. A material of the light-transmitting layer 502 only needs to have a high transmittance with respect to the wavelength of the reproduction light. The light-transmitting layer 502 may be made of a polycarbonate film and a transparent adhesive, and/or may be provided with a hard coating for surface protection. Further, the thickness of the light-transmitting layer 502 may be changed in accordance with an optical system included in the storage apparatus 107. The light-transmitting layer 502 may be made of a polycarbonate substrate having a thickness of 600 μm, or may have a multi-layer structure, for example.

The first information storage layer 503 is a ROM (Read Only Memory) layer, and is made of a silicon nitride having a thickness of 10 nm. The first information storage layer 503 only needs to have translucency with respect to the wavelength of the reproduction light. Further, the first information storage layer 503 may be made from, for example, a metal nitride (such as a aluminum nitride and a titanium nitride), a metal oxide film (such as a tantalum oxide, a titanium oxide, and a silicon oxide), or a metal complex oxide (such as Zns-SiO₂).

The intermediate layer 504 is made of, for example, a transparent ultraviolet-cured resin having a thickness of 25 μm. A surface of the intermediate layer 504 which surface is in contact with the first information storage layer 503 is provided with prepits in accordance with information to be stored in the first information storage layer 503. The prepits make a protrusion/depression pattern. A material of the intermediate layer 504 only needs to have a high transmittance with respect to the wavelength of the reproduction light, and is not particularly limited. Further, the intermediate layer 504 may have a multi-layer structure.

The second information storage layer 505 is a rewritable RE (Rewritable) layer. For example, the second information storage layer 505 is made of a thin-film having a seven-layer structure including (i) a first protective film 505a made of Zns-SiO₂ having a thickness of 35 nm, (ii) a second protective film 505b made of ZrO, (iii) a storage layer 505c made of GeTeSb₂Te₃ having a thickness of 10 nm, (iv) a third protective film 505d made of ZrO having a thickness of 5 nm, (v) a fourth protective film 505e made of Zns-SiO₂ having a thickness of 35nm, (vi) a fifth protective film 505f made of ZrO having a thickness of 5 nm, and (vii) a reflection film 505g made of APC (AgPdCu) having a thickness of 20 nm, which are stacked in the order from the side from which the reproduction light enters. A thickness of the second information storage layer 505 and the number of layers included in the second information storage layer 505 are not particularly limited, but only need to be the ones allowing the second information storage layer 505 to function as an RE layer.

The substrate 506 is made of, for example, a polycarbonate having a thickness of 1.1 mm. The substrate 506 only needs to allow a groove to be made on its surface and have a predetermined strength, and may be made from a polyolefin resin, a metal, or the like.

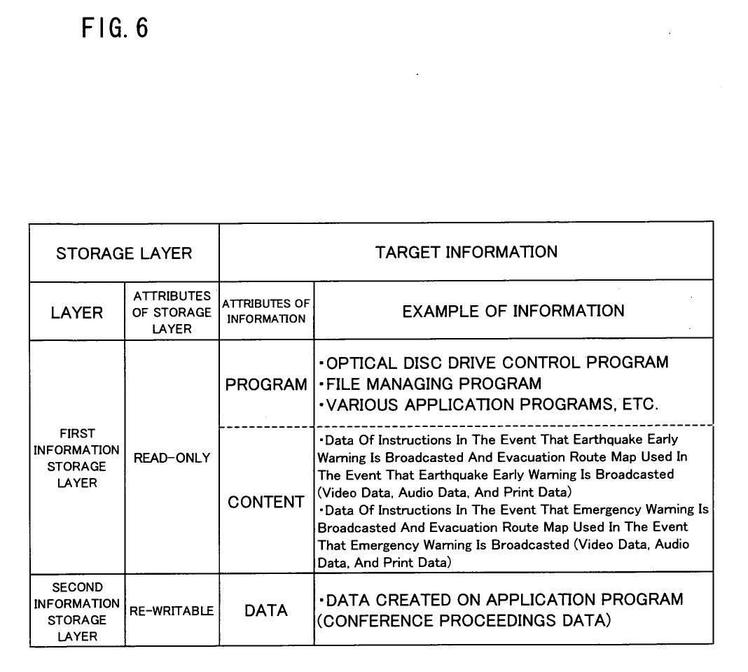

FIG. 6 shows attributes of information to be stored in the Blu-ray disc 500 in a case where the Blu-ray disc 500 is used in the information output system 100. As illustrated in FIG. 6, the first information storage layer (ROM layer) 503 stores various programs for causing various operations of the storage apparatus 107 to operate. Further, the first information storage layer 503 stores content. In a case where the Blu-ray disc 500 is used in the information output system 100, the first information storage layer 503 stores (i) customized instructions in the event of an earthquake and (ii) a customized evacuation route map in the event of an earthquake.

The second information storage layer (rewritable RE layer) 505 can record and store data concerning conference proceedings displayed on the display section 105.

In the present embodiment, with the object of securing safety and reliability of information to be stored on the first information storage layer (first storage area) 503, the first information storage layer 503 is arranged in the form of a ROM (similar to a commonly-used CD-ROM, a commonly-used DVD-ROM, and a commonly-used BD-ROM) in which prepits, making a protrusion/depression pattern, are formed in accordance with subject information. For this reason, it is possible to prevent stored data from being deleted accidentally or being altered. Further, in view of the foregoing object, the first information storage layer (first storage area) 503 may also be a write-once medium (similar to a commonly-used CD-R, a commonly-used DVD-R, and a commonly-used BD-R) on which information writing is performable only once.

In each case, written information has a property of prohibiting the written information from being re-written by changing its physical characteristics, so that safety and reliability of the information are secured.

Meanwhile, in a case where the first information storage layer (first storage area) 503 is a medium (similar to a commonly-used CD-RW, a commonly-used DVD-RW, and a commonly-used BD-RE) on which information writing is performable as many times as desired, identification information (write protect) for prohibiting writing may be added to the first information storage layer 503, for the purpose of realizing logical storage prohibition. In this case, although safety and reliability of the information are not so high as those in the above-mentioned method for physically prohibiting the first information storage layer from being recorded, it is possible to logically prohibit the first information storage layer from being recorded only in a desired area out of the whole area which is physically rewritable. This makes it possible to set writing prohibition with respect to desired information, thereby improving convenience.

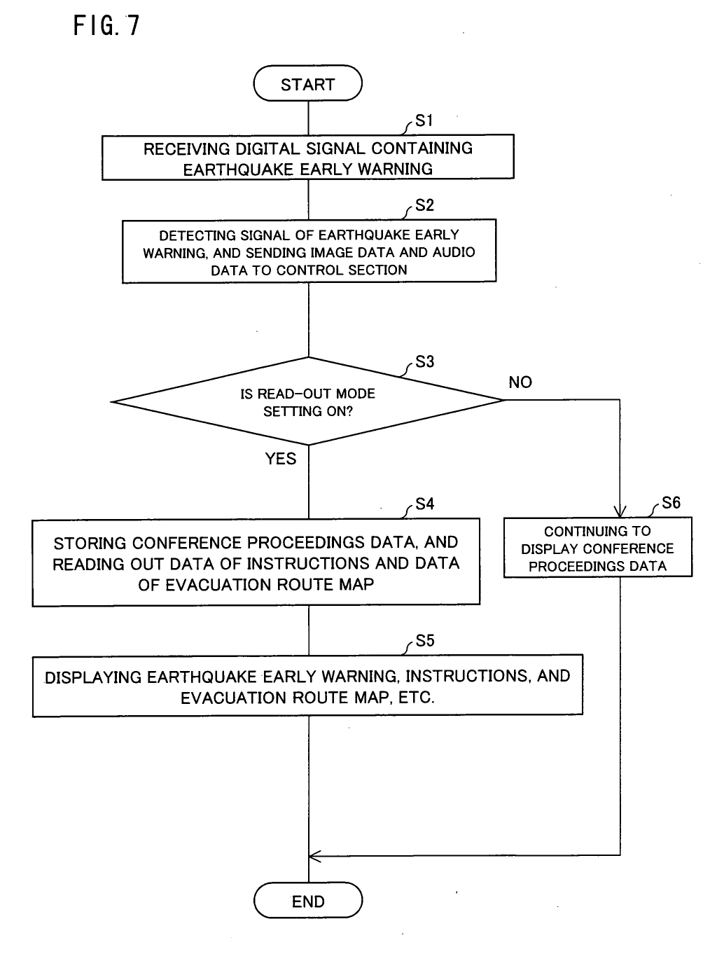

Next, the following describes, with reference to a flow chart illustrated in FIG. 7, a process carried out by the information output system 100.

Firstly, in a step S1, a digital signal containing an earthquake early warning transmitted from a digital terrestrial TV broadcast station is received by the digital terrestrial TV broadcast receiver 103 via the UHF antenna 102. In a step S2, the signal detection section 104 detects a signal of the earthquake early warning from the digital signal, containing the earthquake early warning, received by the digital terrestrial TV broadcast receiver 103, and transmits, to the control section 106, a signal indicating that the signal of the earthquake early warning has been detected. In a step S3, the control section 106 receives the signal indicating that the signal of the earthquake early warning has been detected by the signal detection section 104, and also receives video data and character data concerning the earthquake early warning, the video data and the text data being obtained via the signal detection section 104. Then, it is determined whether or not the read-out mode setting is ON.

In a case where it is determined, in the step S3, that the read-out mode setting is ON, the process proceeds to a step S4. In the step S4, the conference proceedings data is stored in the storage apparatus 107, and video data, audio data, and print data each of which relates to (i) the instructions in the event of an earthquake, and (ii) the evacuation route map used in the event of an earthquake, are read out of the storage apparatus 107. In other words, the storage control section 126 causes conference proceedings data to be stored on the second information storage layer 505 of the Blu-ray disc 500 in the storage apparatus 107, and reads, out of the first information storage layer 503 of the Blu-ray disc 500 in the storage apparatus 107, video data, audio data, and print data concerning instructions in the event of an earthquake (corresponding to a case where an earthquake early warning is received), an evacuation route map used in the event of an earthquake, and/or the, like.

In a step S5, each of the video data concerning (i) the earthquake early warning, (ii) the instructions in the event of an earthquake, and (iii) the evacuation route map used in the event of an earthquake is sent to the display section, and the display control is carried out. Further, each of the audio data concerning (i) the earthquake early warning, (ii) the instructions in the event of an earthquake, and (iii) the evacuation route map used in the event of an earthquake is sent to the audio output apparatus, and the audio output control is carried out. Furthermore, each of the print data concerning (i) the earthquake early warning, (ii) the instructions in the event of an earthquake, and (iii) the evacuation route map used in the event of an earthquake is sent to the printing apparatus, and the print control is carried out. In other words, the display control section 116 causes the display section 105 to display (i) the video data and the character data of the earthquake early warning and (ii) the video data, read out of the first information storage layer 503 in the storage apparatus 107, concerning the instructions in the event of an earthquake, the evacuation route map used in the event of an earthquake, and/or the like. Further, the audio control section 146 causes the audio output apparatus 109 to output the audio data, read out of the first information storage layer 503 in the storage apparatus 107, concerning the instructions in the event of an earthquake, and/or the like. Furthermore, the storage control section 126 transmits, to the printing apparatus 108, the print data, read out of the first information storage layer 503 in the storage apparatus 107, concerning the instructions in the event of an earthquake, the evacuation route map used in the event of an earthquake, and/or the like. Then, the storage control section 126 causes the printing apparatus 108 to print out the print data.

In a case where it is determined, in the step S3, that the read-out mode setting is OFF, the process proceeds to the step S6, so that the conference proceedings data is displayed continuously.

Thus, a series of processing of the information output system 100 is ended.

### Second Embodiment

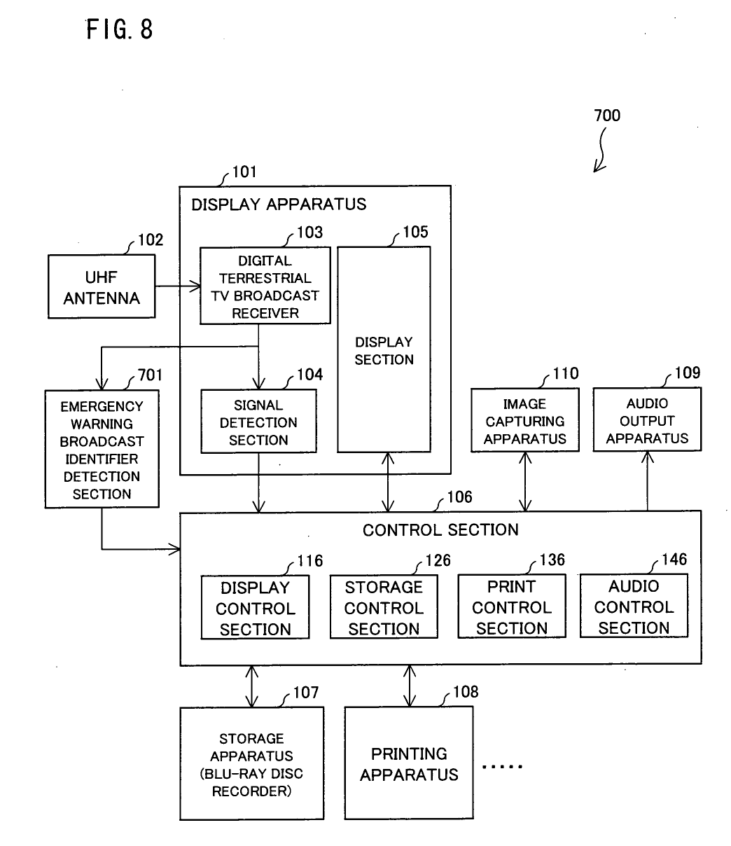

The following describes, with reference to FIG. 8 through FIG. 10, another embodiment of the present invention. For convenience of explanation, members having the same functions as those explained in First Embodiment are given the same signs as First Embodiment, and explanations thereof are omitted here.

As illustrated in FIG. 8, in addition to the arrangement of the information output system 100 of First Embodiment, an information output system (information output apparatus, electronic conference system) 700 according to the present embodiment is connected with an emergency warning broadcast identifier detection section (signal detection section) 701, which is provided between a digital terrestrial TV broadcast receiver 103 and a control section 106.

The information output system 700 receives an emergency warning broadcast as emergency information. In a case where the digital terrestrial TV broadcast receiver 103 receives an emergency warning broadcast containing a signal of an emergency warning broadcast identifier from a digital terrestrial TV broadcast station (not illustrated) via a UHF antenna 102, the emergency warning broadcast identifier detecting section 701 transmits, to the control section 106, a signal indicating that the emergency warning broadcast identifier has been detected.

When the control section 106 receives, from the emergency warning broadcast identifier detecting section 701, the signal indicating that the emergency warning broadcast identifier has been detected, the following processing is carried out. A display control section 116 transmits, to a display section 105, video data, character data, and/or the like of the emergency warning broadcast received by the digital terrestrial TV broadcast receiver 103, and causes the display section 105 to display the video data, the character data, and/or the like. Further, an audio control section 146 transmits, to an audio output apparatus 109, audio data of the emergency warning broadcast, and causes the audio output apparatus 109 to output the audio data. Furthermore, a storage control section 126 causes conference proceedings data 201 to be stored on a Blu-ray disc in a storage apparatus 107, and reads, out of the Blu-ray disc in the storage apparatus 107, video data, audio data, and print data concerning (i) instructions in the event that an emergency warning is broadcasted and (ii) an evacuation route used in the event that an emergency warning is issued. Here, the instructions in the event that an emergency warning is broadcasted include (i) instructions in the event of an earthquake and (ii) instructions in the event that a tsunami warning/advisory is issued. There is a case where merely either one of the information is read out in accordance with the emergency warning broadcast. Further, the evacuation route map used in the event that an emergency warning is broadcasted includes (i) an evacuation route map used in the event of an earthquake and (ii) an evacuation route map used in the event of a tsunami. There is a case where merely either one of the maps is read out in accordance with the emergency warning broadcast. Furthermore, the display control section 116 transmits, to the display section 105, video data concerning (i) the instructions in the event that the emergency warning is broadcasted and (ii) the evacuation route used in the event that the emergency warning is broadcasted, and causes the display section 105 to display the instructions and the evacuation route. The video data and the character data of the emergency warning broadcast may be displayed together with the video data concerning (i) the instructions in the event that the emergency warning is broadcasted and (ii) the evacuation route used in the event that an emergency warning is broadcasted. The audio control section 146 transmits, to the audio output apparatus 109, the audio data of the instructions in the event that an emergency warning is broadcasted, and causes the audio output apparatus 109 to output the audio data. A print control section 136 transmits, to a printing apparatus 108, the print data concerning (i) the instructions in the event that the emergency warning is broadcasted and (ii) the evacuation route used in the event that an emergency warning is broadcasted, and causes the printing apparatus 108 to print out the print data. Here, note that the control section 106 is connected with an image capturing apparatus 110. Based on imaged data obtained in such a manner that the image capturing apparatus 110 captures an image of conference participants, the print control section 136 may count how mane the conference participants are included in the image data, and cause the printing apparatus 108 to print the print data on sheet(s) as many as the counted of the conference participants. This causes the print data to be printed for each of the conference participants, thereby making it possible to provide the printed matters to all of the conference participants.

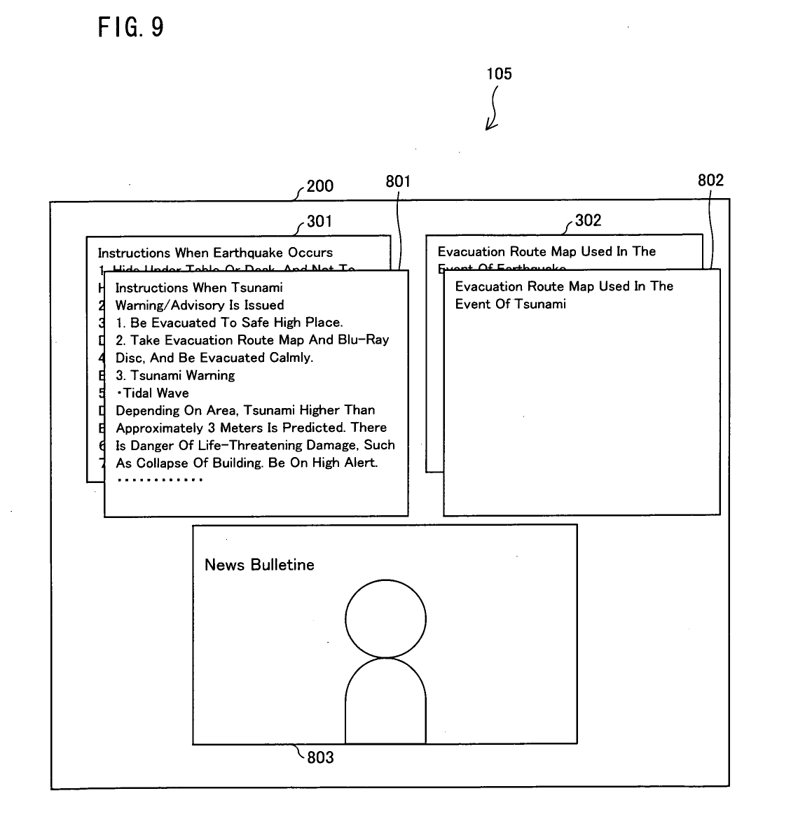

FIG. 9 shows a display example of the display section 105 observed in a case where the emergency warning broadcast identifier detecting section 701 detects an emergency warning broadcast identifier. In an upper half of a display screen 200 of the display section 105, (i) instructions 301 in the event of an earthquake, titled “INSTRUCTIONS WHEN EARTHQUAKE OCCURS” and (ii) instructions 801 in the event that a tsunami warning/advisory is issued, titled “INSTRUCTIONS WHEN TSUNAMI WARNING/ADVISORY IS ISSUED” are alternately displayed. Here, the instructions 301 and the instructions 801 are displayed alternately, however, the instructions 301 and the instructions 801 may be displayed at the same time. Further, in the upper half of the display screen 200 of the display section 105, (i) an evacuation route map 302 used in the event of an earthquake and (ii) an evacuation route map 802 used in the event of a tsunami are alternately displayed. Here, the evacuation route map 302 and the evacuation route map 802 are alternately displayed, however, the evacuation route map 302 and the evacuation route map 802 may be displayed at the same time.

Here, (i) the instructions in the event that an emergency warning is issued and (ii) the evacuation route map in the event that an emergency warning is issued, both of which have been read, may be printed, for example, in the following order: the instructions 301 in the event of an earthquake; the evacuation route map 302 used in the event of an earthquake; the instructions 801 in the event that a tsunami warning/advisory is issued; and the evacuation route map 802 used in the event of a tsunami. Instead of this, for example, the instructions 301 in the event of an earthquake and the evacuation route map 302 used in the event of an earthquake may be printed in one page (2 in 1), and the instructions 801 the event that a tsunami warning/advisory is issued and the evacuation route map 802 used in the event of a tsunami may be printed in another one page (2 in 1). Further, instead of this, the instructions 301 in the event of an earthquake, the evacuation route map 302 used in the event of an earthquake, the instructions 801 in the event that a tsunami warning/advisory is issued, and the evacuation route map 802 used in the event of a tsunami may be printed in one printing sheet collectively (4 in 1).

Furthermore, instead of this, the instructions 301 in the event of an earthquake and the evacuation route map 302 used in the event of an earthquake may be respectively printed on both surfaces of one printing sheet, and the instructions 801 in the event that a tsunami warning/advisory is issued and the evacuation route map 802 used in the event of a tsunami may be respectively printed on both sides of another one printing sheet.

In any case, how to print the above-mentioned information is not particularly limited, as far as printing is carried out so that (i) the instructions 301 in the event of an earthquake corresponds to the evacuation route map 302 used in the event of an earthquake and (ii) the instructions 801 in the event that a tsunami warning/advisory is issued corresponds to the evacuation route map 802 used in the event of a tsunami, and thereby a conference participant can obtain a printed matter clearly showing these correspondences.

In a lower half of the display screen 200 of the display section 105, a news bulletin 803, which is the video data of the emergency warning broadcast, is displayed in real time. Note that the character data may be also displayed.

The audio output apparatus 109 outputs (i) audio data corresponding to the instructions 301 in the event of an earthquake, (ii) audio data corresponding to the instructions 801 in the event that a tsunami warning/advisory is issued, and (iii) audio concerning the news bulletin 803. Here, for example, output control with respect to the audio data and the audio of the news bulletin may be carried out in the following manner. The audio data is outputted once to three times prior to the audio of the news bulletin, and then the output control is switched so as to output the audio of the special newscast. Then, the output control causes the audio of the special newscast to be outputted continuously. Further, instead of this, the output control may be carried out in the following manner. By using a detection and separation device (not illustrated) for (i) detecting and separating video data, audio data, and/or the like of a news bulletin and (ii) transmitting the audio data of the news bulletin to the audio control section 146. The audio data read out of the storage apparatus 107 is outputted continuously until the audio data of the news bulletin is received.

As well as in First Embodiment, the conference proceedings data 201 is stored on the RE layer of the second information storage layer 505 of the Blu-ray disc illustrated in FIG. 5.

Further, in a case where (i) the video data, the audio data, and the print data of the instructions in the event that an emergency warning is broadcasted, and (ii) the video data, the audio data, and the print data of the evacuation route map used in the event that the emergency warning is broadcasted are read out of the storage apparatus 107, the instructions in the event that an emergency warning is broadcasted and the evacuation route map used in the event that an emergency warning is broadcasted, both of which have been customized in accordance with the building having the conference room, or the site conditions of the building, are read out of the first information storage layer 503 of the Blu-ray disc.

Furthermore, the print control section 136 causes the printing apparatus 108 to print (i) the instructions 301 in the event of an earthquake and the evacuation route map 302 in the event of an earthquake, and (ii) the instructions 801 in the event that a tsunami warning/advisory is issued, and the evacuation route map used in the event that a tsunami warning/advisory is issued.

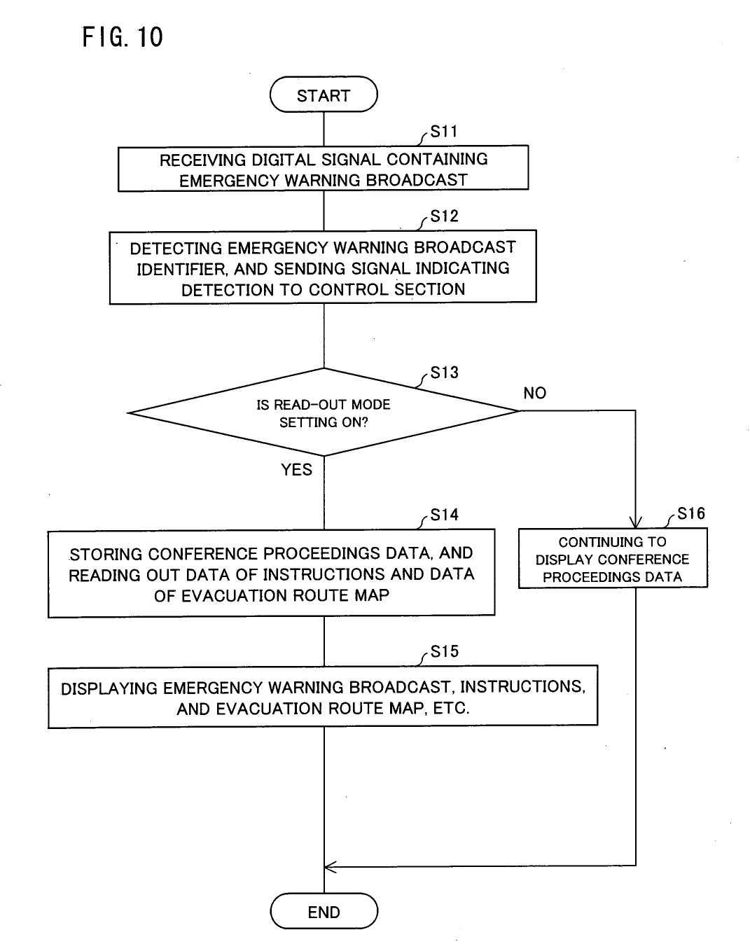

Next, the following explains processing of the information output system 700 with reference to a flow chart of FIG. 10. Firstly, in a step S11, the digital signal containing the emergency warning broadcast transmitted from the digital terrestrial TV broadcast station is received by the digital terrestrial TV broadcast receiver 103 via the UHF antenna 102. In a step S12, the emergency warning broadcast identifier detection section 701 detects the emergency warning broadcast identifier from the digital signal containing the emergency warning broadcast, received by the digital terrestrial TV broadcast receiver 103, and transmits, to the control section 106, the signal indicating that the emergency warning broadcast identifier is detected.

In a step S13, the control section 106 receives the signal of the detection from the emergency warning broadcast identifier detection section 701, and also receives the video data and the audio data of the emergency waning broadcast via the signal detection section 104. Then, the control section 106 determines whether or not the read-out mode setting is ON.

If the read-out mode setting is ON in the step S13, the processing proceeds to a step S14. In the step S14, the conference proceedings data is stored in the storage apparatus 107, and video data, audio data, and print data each of which relates to (i) the emergency warning broadcast, (ii) the instructions in the event of an earthquake, (iii) the evacuation route map used in the event of an earthquake, (iv) the instructions in the event that a tsunami warning/advisory is issued, and (v) the evacuation route map used in the event that a tsunami warning/advisory is issued, are read out of the storage apparatus 107. In other words, the storage control section 126 causes the conference proceedings data to be stored on the second information storage layer 505 of the Blu-ray disc in the storage apparatus 107, and reads, out of the first information storage layer 503 of the Blu-ray disc in the storage apparatus 107, (i) the video data, the audio data, and the print data of the instructions in the event that an emergency warning is broadcasted, and (ii) the video data, the audio data, and the print data of the evacuation route map used in the event that an emergency warning is broadcasted. The instructions in the event that an emergency warning is broadcasted include (i) the instructions in the event of an earthquake, and (ii) the instructions in the event that a tsunami warning/advisory is issued. There is a case where either one of the instructions is read out as the instructions in the case where the emergency warning is broadcasted. Further, the evacuation route map used in the event that an emergency warning is broadcasted includes (i) the evacuation route map used in the event of an earthquake, and (ii) the evacuation route map used in the event of a tsunami. There is a case where either one of the evacuation route maps is read out as the evacuation route map. Then the processing proceeds to a step S15.

In the step S15, each of the video data concerning (i) the emergency warning broadcast, (ii) the instructions in the event of an earthquake, (iii) the evacuation route map used in the event of an earthquake, (iv) the instructions in the event that a tsunami warning/advisory is issued, and (v) the evacuation route map used in the event that a tsunami warning/advisory is issued, is sent to the display section 105, and the display control is carried out. Further, each of the audio data concerning (i) the emergency warning broadcast, (ii) the instructions in the event of an earthquake, (iii) the evacuation route map used in the event of an earthquake, (iv) the instructions in the event that a tsunami warning/advisory is issued, and (v) the evacuation route map used in the event that a tsunami warning/advisory is issued, is sent to the audio output apparatus, and the audio output control is carried out. Furthermore, each of the print data concerning (i) the emergency warning broadcast, (ii) the instructions in the event of an earthquake, (iii) the evacuation route map used in the event of an earthquake, (iv) the instructions in the event that a tsunami warning/advisory is issued, and (v) the evacuation route map used in the event that a tsunami warning/advisory is issued, is sent to the printing apparatus 108, and the print control is carried out. In other words, the display control section 116 causes the display section 105 to display (i) the video data of the emergency warning broadcast, (ii) the video data of the instructions in the event that an emergency warning is broadcasted (read out of the first information storage layer 503 of the Blu-ray disc in the storage apparatus 107), and (iii) the video data of the evacuation route map in the case where the emergency warning is broadcasted (read out of the first information storage layer 503 of the Blu-ray disc in the storage apparatus 107). Further, the audio control section 146 causes the audio output apparatus to output (i) the audio data of the emergency warning broadcast, and (ii) the audio data of the instructions in the event that an emergency warning is broadcasted (read out of the first information storage layer 503 of the Blu-ray disc in the storage apparatus). Furthermore, the print control section 136 transmits, to the printing apparatus 108, (i) the print data of the instructions in the event that an emergency warning is broadcasted (read out of the first information storage layer 503 of the Blu-ray disc in the storage apparatus 107), and (ii) the print data of the evacuation route map in the event that an emergency warning is broadcasted (read out of the first information storage layer 503 of the Blu-ray disc in the storage apparatus 107), and causes the printing apparatus 108 to print both of the print data.

If the read-out mode setting is OFF in the step S13, the processing proceeds to a step S16, and the display control section 116 causes the display section 105 to continue to display the conference proceedings data.

### Third Embodiment

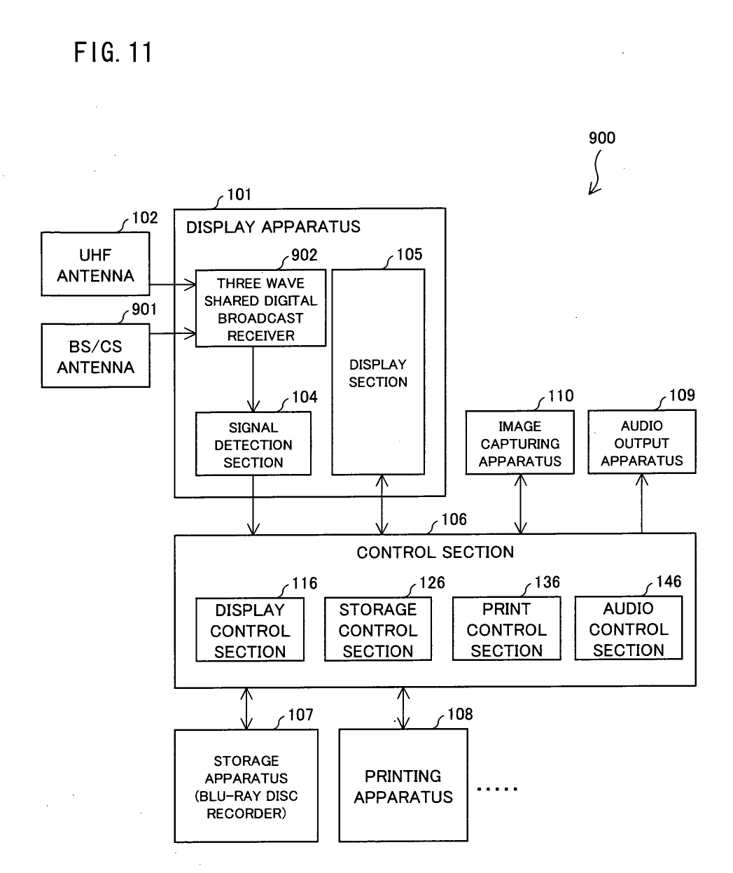

The following explains still another embodiment of the present invention with reference to FIG. 11. For convenience of explanation, members having the same functions as those explained in First Embodiment are given the same signs as First Embodiment, and explanations thereof are omitted here.

FIG. 11 is a block diagram illustrating an information output system (information output apparatus, electronic conference system) 900 of the present embodiment. In place of the digital terrestrial TV broadcast receiver 103, the information output system 900 includes a three-wave shared digital TV broadcast receiver (signal receiving apparatus) 902, which receives signals of digital broadcasts received by a UHF antenna 102, and a BS/CS antenna 901.

If a signal detection section 104 detects, from a signal received by the three-wave shared digital TV broadcast receiver 902, an earthquake early warning, the signal detection section 104 transmits, to a control section 106, a signal indicating that a signal of the earthquake early warning is detected. The processing carried out by the control section 106 is the same as in First Embodiment.

Note that, not illustrated though, the information output system 900 may be connected with an emergency warning broadcast identifier detection section 701 for detecting, from the signal received by the three-wave shared digital TV broadcast receiver 902, an emergency warning broadcast identifier, as in Second Embodiment.

Here, the foregoing embodiments explain a case where disaster information (such as an earthquake early warning and an emergency warning broadcast) is detected from a digital terrestrial broadcast, or a BS/CS digital broadcast. However, the disaster information differs depending on a country or a region, as a matter of course. Accordingly, the disaster information includes any disaster information regarding not only an earthquake and a tsunami but also any natural disasters and any man-made disasters, such as a tornado, a hurricane, a typhoon, a volcano, a fire, a fall of a rocket, a fall of a satellite, and a fall of a meteorite. Moreover, the disaster information may be related not to a disaster but to any information, as long as the information is emergency information, such as information related to: terrorism; a crime; and an incident. Further, the disaster information may be included not only in the broadcasts described above but also in another broadcast. That is, the present invention can be applied to a case where a user goes to a strange land, a strange area, or a strange country, and information for evacuating the user safely without suffering from a natural disaster or a man-made disaster is broadcasted.

Further, in the explanations of the present embodiment described above, an information output apparatus according to the present invention is used in a conference room. However, the information output apparatus according to the present invention can be used in any situations where people gather around, such as various event sites, an event at a hotel, a photo studio, a strategy meeting for a sport, a medical related place, mass media (a TV broadcast station or a publisher, for example), and an amusement facility.

Moreover, in the embodiments described above, the storage apparatus 107 is an apparatus using a Blu-ray disc (optical information storage medium (optical disc)). However, the storage apparatus 107 may be a removable hard disc, a semiconductor memory device, or the like.

Each block of the control section 106 can be arranged by hardware logic, or can be realized by software with the use of a CPU.

That is, the control section 106 includes: a CPU (central processing unit) for executing instructions from a control program that realizes each of the functions; a ROM (read only memory) in which the program is stored; a RAM (random access memory) for operating the program; a storage apparatus (storage medium) such as a memory in which the program and various data are stored; and the like. Note that the storage apparatus may be the storage apparatus 107. An object of the present invention can be also achieved in such a manner that (i) the control section 106 is provided with a computer-readable storage medium in which program codes (executable program, intermediate code program, source program) of the control program (which is software for realizing the functions described above) of the control section 106 are stored, and (ii) the computer (alternatively a CPU or an MPU) of the control section 106 reads out and executes the program codes.

Further, it is possible to have an arrangement in which the control section 106 is connected to a communication network, and provided with the program codes via the communication network. The communication network is not particularly limited, and may be the Internet, an intranet, an extranet, a LAN, an ISDN, a VAN, a CATV communication network, a virtual private network, a phone-line network, a mobile communication network, a satellite communication network, or the like. Furthermore, a transmission medium constituting the communication network is not particularly limited, and may be a closed-circuit, such as IEEE 1394, a USB, a power-line carrier, a cable TV circuit, a phone line, and an ADSL circuit, or a wireless medium, such as infrared radiation (IrDA or a remote control, for example), Bluetooth (Registered Trademark), an 802.11 wireless LAN, an HDR, a mobile phone network, a satellite circuit, and a digital terrestrial wave network. The present invention can also be realized by the program codes in the form of a computer data signal embedded in a carrier wave, which is the program that is electrically transmitted.

An information output apparatus of the present invention includes: a signal receiving apparatus; a display apparatus; a printing apparatus; a signal detection section for detecting, from a signal received by the signal receiving apparatus, a signal of emergency information that is information for an emergency situation; a storage apparatus for storing evacuation information that is associated with the emergency information and is used in an evacuation from an installation site of the display apparatus; and a control section which, if the signal detection section detects the signal of the emergency information, (i) causes the storage apparatus to store display information that is being displayed on the display apparatus, (ii) reads the evacuation information out of the storage apparatus, (iii) causes the display apparatus to display the evacuation information and the emergency information, and (iv) causes the printing apparatus to print out the evacuation information.

With the arrangement, if the signal of the emergency information is detected, (i) the display information that is being displayed at the time of the detection is stored in the storage apparatus, (ii) the evacuation information that is associated with the emergency information and used in the evacuation from the installation site of the display device, is displayed on the display apparatus, and (iii) the evacuation information is printed out by the printing apparatus. Therefore, when the signal of the emergency information is detected, a user who is in the installation site of the display apparatus can (i) detect the emergency information displayed on the display apparatus, (ii) check the evacuation information, and (iii) be evacuated. Further, the evacuation information is printed out so that the user can be evacuated while carrying the printed matter. Here, the evacuation information is information used in the evacuation from the installation site of the display apparatus. That is, the evacuation information has been customized in accordance with the installation site of the display apparatus. Since the user is evacuated while carrying the printed matter on which the evacuation information customized in accordance with the installation site of the display apparatus is printed, so the user can be evacuated without losing his/her way or getting into a panic in an emergency situation. Thus, with the arrangement, it is possible to appropriately evacuate a user who is in a place where the display apparatus is installed.

In addition to the arrangement described above, in the information output apparatus of the present invention, the emergency information may be information on a disaster, and the evacuation information may contain at least one of information on an evacuation route, and information on instructions in a case where a disaster occurs.

With the arrangement, in a case where a disaster occurs, the information on the evacuation route is displayed on the display apparatus, and printed out. Thereby, a user can be evacuated while checking the evacuation route. Further, the evacuation information may contain the information on the instructions in a case where a disaster occurs. With the evacuation information including the information on the instructions in a case where a disaster occurs, it becomes possible to instruct a user to act appropriately in accordance with the disaster, and get the user calmed down.

In addition to the arrangements described above, the information output apparatus of the present invention may further include an audio output apparatus, wherein: the evacuation information may include audio information; and in a case where the signal detection section detects the signal of the emergency information, the control section may (i) read the audio information included in the evacuation information and cause (ii) the audio output apparatus to output the audio information.

With the arrangement, the audio information included in the evacuation information is outputted. Therefore, it becomes possible to appropriately evacuate a user with the audio information in addition to the video information and the print information.

In addition to the arrangements described above, in the information output apparatus of the present invention, the storage apparatus may have an arrangement in which a storage medium in which at least the evacuation information is stored is detachable.

With the arrangement, it is possible to take out the storage medium in which the evacuation information is stored. Here, the evacuation information is information used in the evacuation from the installation site of the display apparatus. In a case where the information output apparatus is used for a company, for example, the instructions in an emergency situation, or the evacuation route in a building differs depending on a room arrangement of a conference room of the company, or a building. There is a case where the evacuation information is confidential information of the company. With the arrangement, in a case where the emergency information is received (in a case where a disaster occurs, for example), a user can (i) take, out of the storage apparatus, the storage medium in which such confidential information is stored, and then, (ii) be evacuated while carrying the storage medium. Thus, it is possible to prevent leakage of confidential information.

Here, the storage medium may include a first storage region for storing the evacuation information, and a second storage region for storing the display information. It is preferable that the first storage region is prohibited from being recorded physically and logically. With the arrangement in which the first storage region is prohibited from being recorded, it is possible to prevent the evacuation information (i.e. confidential information) stored in the first storage region from being leaked or being altered. Further, the second storage region stores the display information. With the arrangement, in a case of emergency, it becomes possible for a user to (i) take, out of the storage apparatus, the storage medium in which the evacuation information (i.e. confidential information), and the display information that is being displayed on the display apparatus at the time are stored, and (ii) be evacuated while carrying the storage medium. Note that in a case where the evacuation information contains non-confidential information (such as a small scale evacuation route map, and general instructions in a case of a disaster), such information may be stored in the second storage region.

Further, the storage medium may be an optical information storage medium whose information writing and information reading is performed by use of a laser beam, and the first storage region may include a ROM medium, or a write-once medium on which writing is performable only once. Furthermore, the storage medium may have a layer structure. The first storage region may be arranged to be a first storage layer, and the second storage region may be arranged to be a second storage layer.

Here, assume that the display apparatus is used to display conference proceedings in a conference room, or the like, and the storage medium is a Blu-ray disc. In this case, by storing the image data of the conference proceedings or the like on the Blu-ray disc, it becomes possible for a user to, in a case of an emergency situation where the emergency information is received, for example, in a case where a disaster occurs, (i) take only the Blu-ray disc out of the storage apparatus, and then (ii) be evacuated while carrying the Blu-ray disc. Accordingly, if the information output apparatus is completely destroyed in the disaster, and cannot be repaired, the user can keep the image data of the conference proceedings or the like. Therefore, the conference can be resumed smoothly, and previous conference proceedings or the like cannot be wasted. Further, even if the image data of the conference proceedings that is being displayed contains a full high definition image (an image of approximately 2.07 million pixels, 1920 pixel long×1080 pixel wide, for example), it is possible to store the image clearly and vividly, and read out the image.

In addition to the arrangements described above, in the information output apparatus of the present invention, an image capturing apparatus may obtain image data by capturing an image of the installation site of the display apparatus, and the control section may (i) count how many people are included in the image data and (ii) control the printing apparatus to perform printing on sheet(s) as many as the count of the people.

With the arrangement, when the evacuation information is printed out, the number of the printed matter(s) is set to the number of the people included in the image data obtained in such a manner that the image capturing apparatus captures the image of the installation site of the display apparatus. Therefore, it is possible to give out the printed matter to each of the users being in the installation site of the display apparatus. Thereby, each of the users can be evacuated while carrying the printed matter on which the evacuation information is printed.

In addition to the arrangements described above, in the information output apparatus of the present invention, the signal receiving apparatus may receive a signal of a digital terrestrial TV broadcast, and the emergency information may be a signal of an earthquake early warning included in the digital terrestrial TV broadcast.

With the arrangement, in a case where the earthquake early warning is included in the signal of the digital terrestrial TV broadcast thus received, it is possible to appropriately evacuate a user from the installation site of the display apparatus.

In addition to the arrangements described above, in the information output apparatus of the present invention, the signal receiving apparatus may receive a signal of a digital terrestrial TV broadcast, and the signal of the emergency information may be a signal of an emergency warning broadcast identifier broadcasted from a broadcast station of the digital terrestrial TV broadcast.

With the arrangement, in a case where the signal of the emergency warning broadcast identifier is received, it is possible to appropriately evacuate a user from the installation site of the display apparatus.

Further, in order to attain the above object, an information output method by use of an information output apparatus including: a signal receiving apparatus; a display apparatus; a printing apparatus; a signal detection section for detecting, from a signal received by the signal receiving apparatus, a signal of emergency information that is information for an emergency situation; and a storage apparatus for storing evacuation information that is associated with the emergency information and is used in an evacuation from an installation site of the display apparatus, includes the steps of: in a case where the signal detection section detects the signal of the emergency information, (i) causing the storage apparatus to store information that is being displayed on the display apparatus at the time of the detection; (ii) reading the evacuation information out of the storage apparatus; (iii) causing the display apparatus to display the evacuation information and the emergency information; and (iv) causing the printing apparatus to print out the evacuation information.

With the method, it is possible to realize the same effect as the information output apparatus of the present invention. Thereby, it becomes possible to appropriately evacuate a user from an installation site of the display apparatus.

Further, the information output apparatus of the present invention may be realized by use of a computer. In this case, the present invention includes a control program for causing a computer to function as a control section of the information output apparatus, and a computer-readable storage medium in which the control program is stored.

With these arrangements, by causing a computer to read out and execute the control program, it becomes possible to realize the same effect as the information output apparatus of the present invention.

Further, in order to attain the above object, an electronic conference system of the present invention includes any one of the information output apparatuses described above. The electronic conference system of the present invention can realize the same effect as the information output apparatus.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. An information output apparatus comprising:
a signal receiving apparatus;
a display apparatus;
a printing apparatus;
a signal detection section for detecting, from a signal received by the signal receiving apparatus, a signal of emergency information that is information for an emergency situation;
a storage apparatus for storing evacuation information that is associated with the emergency information and is used in an evacuation from an installation site of the display apparatus; and
a control section which, if the signal detection section detects the signal of the emergency information, (i) causes the storage apparatus to store display information that is being displayed on the display apparatus, (ii) reads the evacuation information out of the storage apparatus, (iii) causes the display apparatus to display the evacuation information and the emergency information, and (iv) causes the printing apparatus to print out the evacuation information, the storage apparatus employing an optical information storage medium comprising:
a first storage layer which allows only information reading by use of a laser beam, in which first storage layer the evacuation information is stored; and
a second storage layer which is a re-writable storage layer, the control section causing the second storage layer to store the display information, and reading the evacuation information out of the first storage layer.

2. The information output apparatus according to claim 1, wherein:
the emergency information is information on a disaster, and the evacuation information contains at least one of information on an evacuation route, and information on instructions in a case where a disaster occurs.

3. The information output apparatus according to claim 1, further comprising an audio output apparatus, wherein:
the evacuation information includes audio information; and
in a case where the signal detection section detects the signal of the emergency information, the control section (i) reads the audio information included in the evacuation information and (ii) causes the audio output apparatus to output the audio information.

4. The information output apparatus according to claim 1, wherein:
the storage apparatus has an arrangement in which the optical information storage medium is detachable.

5. The information output apparatus according to claim 1, wherein:
the first storage layer is physically prohibited from being recorded.

6. The information output apparatus according to claim 1, wherein:
the first storage layer is logically prohibited from being recorded.

7. The information output apparatus according to claim 1, wherein:
the first storage layer includes a ROM medium or a write-once medium on which writing is performable only once.

8. The information output apparatus according to claim 1, wherein:
an image capturing apparatus obtains image data by capturing an image of the installation site of the display apparatus, and the control section counts how many people are included in the image data and controls the printing apparatus to perform printing on sheet(s) as many as the count of the people.

9. The information output apparatus according to claim 1, wherein:
the signal receiving apparatus receives a signal of a digital terrestrial TV broadcast, and the signal of the emergency information is a signal of an earthquake early warning included in the digital terrestrial TV broadcast.

10. The information output apparatus according to claim 1, wherein:
the signal receiving apparatus receives a signal of a digital terrestrial TV broadcast, and the signal of the emergency information is a signal of an emergency warning broadcast identifier broadcasted from a broadcast station of the digital terrestrial TV broadcast.

11. An electronic conference system comprising:
a signal receiving apparatus;
a display apparatus;
a printing apparatus;
a signal detection section for detecting, from a signal received by the signal receiving apparatus, a signal of emergency information that is information for an emergency situation;
a storage apparatus for storing evacuation information that is associated with the emergency information and is used in an evacuation from an installation site of the display apparatus; and
a control section which, if the signal detection section detects the signal of the emergency information, (i) causes the storage apparatus to store display information that is being displayed on the display apparatus, (ii) reads the evacuation information out of the storage apparatus, (iii) causes the display apparatus to display the evacuation information and the emergency information, and (iv) causes the printing apparatus to print out the evacuation information, the storage apparatus employing an optical information storage medium comprising:
a first storage layer which allows only information reading by use of a laser beam, in which first storage layer the evacuation information is stored; and
a second storage layer which is a re-writable storage layer, the control section causing the second storage layer to store the display information, and reading the evacuation information out of the first storage layer.

12. An information output method using an information output apparatus,
the information output apparatus comprising:
a signal receiving apparatus;
a display apparatus;
a printing apparatus;
a signal detection section for detecting, from a signal received by the signal receiving apparatus, a signal of emergency information that is information for an emergency situation; and
a storage apparatus for storing evacuation information that is associated with the emergency information and is used in an evacuation from an installation site of the display apparatus, the storage apparatus being an optical information storage medium comprising:
a first storage layer which is a storage region allowing only information reading by use of a laser beam, in which first storage layer the evacuation information is stored; and
a second storage layer is a re-writable storage layer,
the information output method comprising the steps of:
in a case where the signal detection section detects the signal of the emergency information, (i) writing information that is being displayed on the display apparatus on the second storage layer;
(ii) reading the evacuation information out of the first storage layer;
(iii) causing the display apparatus to display the evacuation information and the emergency information; and
(iv) causing the printing apparatus to print out the evacuation information.

13. A computer-readable storage medium for storing a control program for controlling an information output apparatus comprising:
a signal receiving apparatus;
a display apparatus;
a printing apparatus;
a signal detection section for detecting, from a signal received by the signal receiving apparatus, a signal of emergency information that is information for an emergency situation; and
a storage apparatus for storing evacuation information that is associated with the emergency information and is used in an evacuation from an installation site of the display apparatus, the storage apparatus being an optical information storage medium comprising:
a first storage layer which is a storage region allowing only information reading by use of a laser beam, in which first storage layer the evacuation information is stored; and
a second storage layer is a re-writable storage layer, the control program causing a computer to execute the steps of:
in a case where the signal detection section detects the signal of the emergency information, (i) writing information that is being displayed on the display apparatus on the second storage layer;
(ii) reading the evacuation information out of the first storage layer;
(iii) causing the display apparatus to display the evacuation information and the emergency information; and
(iv) causing the printing apparatus to print out the evacuation information.
